(19) United States
(12) Patent Application Publication
(10) Pub. No.: US 2015/0319547 A1
(43) Pub. Date: Nov. 5, 2015

(54) MULTIPLE BARRIER TEST FIXTURE AND METHOD OF TESTING USING THE SAME

(71) Applicant: Brian HARTSELL, Aurora, IL (US)

(72) Inventors: Brian HARTSELL, Aurora, IL (US); Craig TINKER, Hermitage, PA (US); Keith GETZ, Sunnyvale, CA (US)

(73) Assignee: KNOWLES ELECTRONICS, LLC, Itasca, IL (US)

(21) Appl. No.: 14/365,017

(22) PCT Filed: Dec. 14, 2011
(86) PCT No.: PCT/US2011/064881

§ 371 Date: Dec. 30, 2014

(51) Int. Cl. H04R 29/00

(52) U.S. Cl. CPC H04R 29/00

(57) ABSTRACT

A test fixture includes a first barrier structure, a second barrier structure, a gap between the first barrier structure and the second barrier structure, at least one isolator disposed in the gap that is configured to couple the first barrier structure to the second barrier structure, and a test bed disposed within the second barrier structure and configured to have acoustic devices coupled thereto. The first barrier structure, the second barrier structure, the gap, and the at least one isolator act and are effective to dampen vibrations of the fixture and provide an acoustic isolation for the acoustic devices at the test bed from acoustic or vibrational energy originating from outside the fixture.

### TECHNICAL FIELD

This application relates to test fixtures and, more specifically, to test fixtures that are configured to test acoustic devices.

### BACKGROUND OF THE INVENTION

Various types of acoustic devices (e.g., microphones and receivers) have been used through the years. In these devices, different electrical components are housed together within a housing or assembly. For example, a microphone typically includes a diaphragm and a back plate (among other components) and these components are disposed together within a housing. Other types of acoustic devices such as receivers may include other types of components.

Acoustic devices are used in various types of environments and with or within various other types of devices. For example, microphones and speakers may be used in devices as varied as hearing aids, personal computers, and portable electronic devices. The devices are required to provide reliable service within predetermined service ranges. For example, a microphone in a hearing aid is typically required to operate within these service ranges.

Various tests are often performed on these acoustic devices before being finally assembled into the end device. For example, various tests may be performed that determine whether the devices operate properly. In this respect and to take one example, microphones may be tested by activating these devices and testing their operation and frequency response.

One problem associated with previous test environments is the presence of acoustic noise and vibrations during the test. The noise and vibrations can affect the results of the test, for instance, creating results that are not accurate. Unfortunately, previous test fixtures were often inadequate in preventing these problems. Consequently, the tests sometimes provided inaccurate results causing devices to be released that were in fact defective. This has created user dissatisfaction with these previous approaches.

### BRIEF DESCRIPTION OF THE DRAWINGS

For a more complete understanding of the disclosure, reference should be made to the following detailed description and accompanying drawings wherein:

FIG. 1 comprises a perspective view of a test fixture with two barriers according to various embodiments of the present invention;

FIG. 2 comprises perspective view of the test fixture of FIG. 1 when the test fixture is closed according to various embodiments of the present invention;

FIG. 3 comprises a perspective exploded view of the test fixture shown in FIGS. 1 and 2 according to various embodiments of the present invention;

FIG. 4 comprises a cutaway front view of the test fixture of FIGS. 1-3 according to various embodiments of the present invention;

FIG. 5 comprises a perspective view of a test fixture with two barriers according to various embodiments of the present invention;

FIG. 6 comprises perspective view of the test fixture of FIG. 5 when the test fixture is closed according to various embodiments of the present invention;

FIG. 7 comprises a perspective exploded view of the test fixture shown in FIGS. 5 and 6 according to various embodiments of the present invention;

FIG. 8 comprises a cutaway front view of the test fixture of FIGS. 5-7 according to various embodiments of the present invention;

FIG. 9 comprises a perspective view of a test fixture according to various embodiments of the present invention;

FIG. 10 comprises an exploded perspective view of the test fixture of FIG. 9 according to various embodiments of the present invention;

FIG. 11 comprises a side view of the test fixture of FIGS. 9 and 10 according to various embodiments of the present invention;

FIG. 12 comprises cut-away front view of the test fixture of FIGS. 9-11 according to various embodiments of the present invention;

FIG. 13 comprises a side view of the test fixture of FIGS. 9-12 according to various embodiments of the present invention;

FIG. 14 comprises a side view of the test fixture of FIGS. 9-13 according to various embodiments of the present invention;

FIG. 15 comprises a perspective view of the test fixture of FIGS. 9-14 according to various embodiments of the present invention;

FIG. 16 comprises a flowchart describing usage of the test fixture described herein according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

A testing fixture that includes multiple barrier structures, shells, or sub-housings to shield the tested devices from vibration and acoustic noise is provided. As used herein, the term “barrier structure” refers to a structure, housing, shell or similar arrangement that encloses a test bed and/or other barrier structures. The barrier structures are each preferably sealed (when closed) and in one example are hollow rectangular boxed structures. However, it will be appreciated that the shape of the barrier structure can assume many shapes (e.g., cylindrical or circular shapes in addition to rectangular or square shapes) and that the structure can have various dimensions. It will also be understood that various wires or other electrical conductors may extend through the barrier structures to couple to the to-be-tested devices and allow testing to occur.

In many of these embodiments, the barrier structures are physically isolated from each other using a dampening material that provides the only coupling as between adjoining barrier structures. In one example a viscoelastic polymer mount is used as the dampening material used between the multiple barriers.

In others of these embodiments, a test fixture includes a first barrier structure, a second barrier structure, a gap between the first barrier structure and the second barrier structure, at least one isolator disposed in the gap that is configured to couple the first barrier structure to the second barrier structure, and a test bed disposed within the second barrier structure and configured to have acoustic devices coupled thereto. The first barrier structure, the second barrier structure, the gap, and the at least one isolator act and are effective to dampen vibrations of the fixture and provide an acoustic isolation for the acoustic devices at the test bed from acoustic and/or vibrational energy originating from outside the fixture. In these examples, “vibrational energy” refers to any mechanical energy coupled into the test fixture from the environment or from a machine.

In other aspects, a test fixture includes two or more barrier structures. The first barrier structure is an outer barrier structure and this barrier structure at least partially surrounds or encompasses an inner barrier structure. Within the inner barrier structure is a mounting mechanism or test bed where various acoustic devices to be tested are placed. Together, the inner barrier structure and test bed form an inner core of the test fixture. When the fixture is in the open position, the inner core is rigidly fixed (e.g., by a mechanical mechanism) to provide a consistent location for the tested parts to be inserted and removed from the test fixture. When the test fixture is closed to begin testing, the inner core is only attached to the outer barrier structure through the dampening material (and flexible wiring to provide the electrical connections) and this provides maximum acoustic isolation for the tested devices. The dampening material absorbs vibrations and acts to isolate the tested devices from vibrations of the test fixture or environment. Any number of barrier structures may surround the inner core.

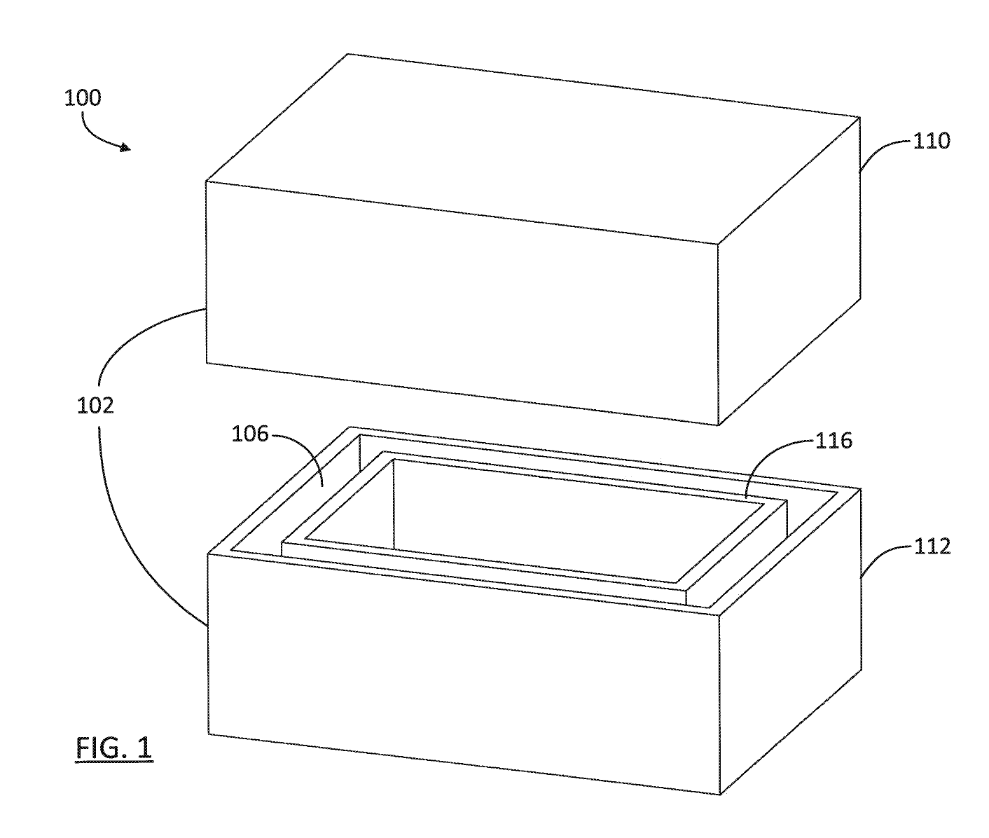

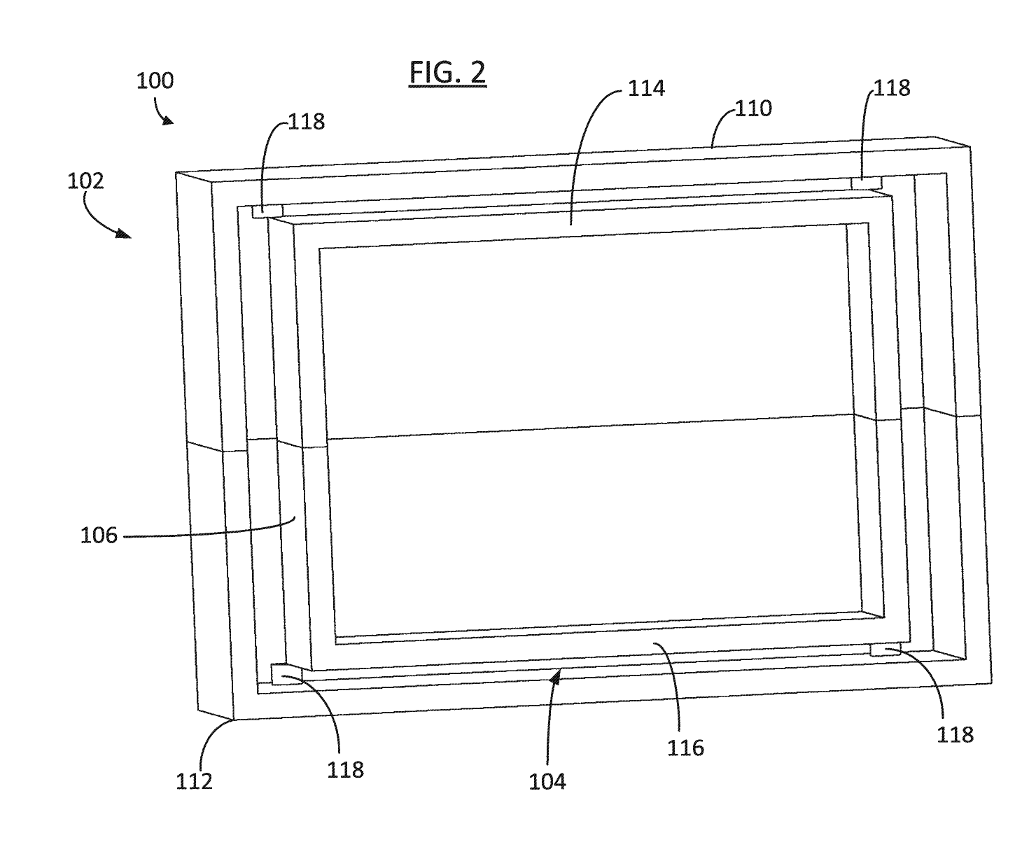

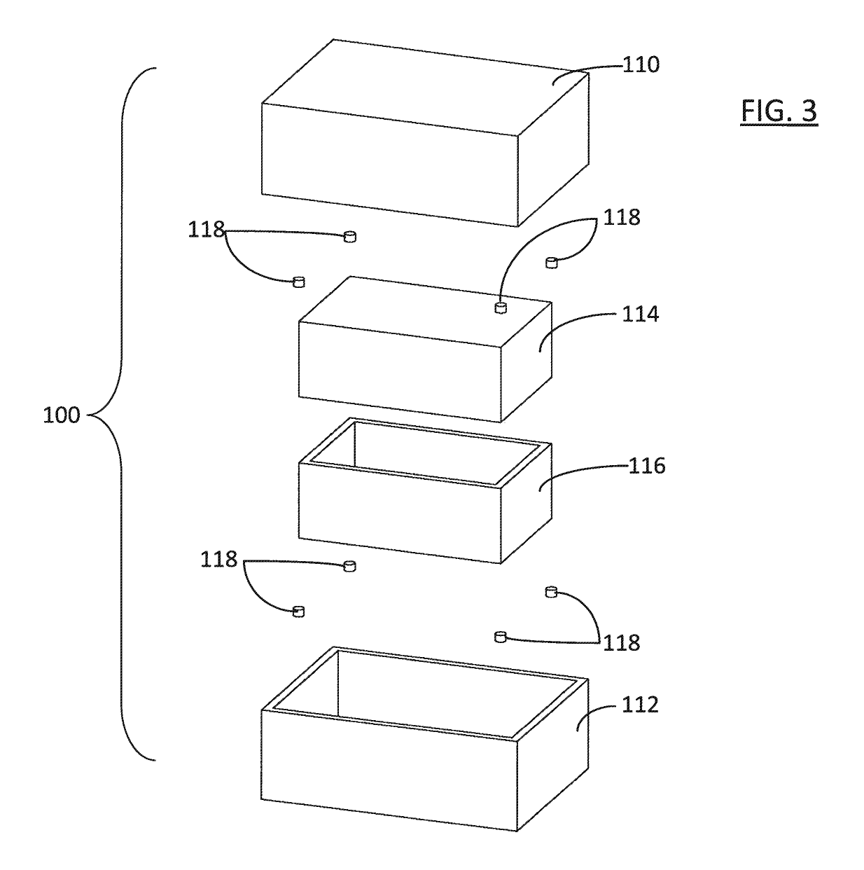

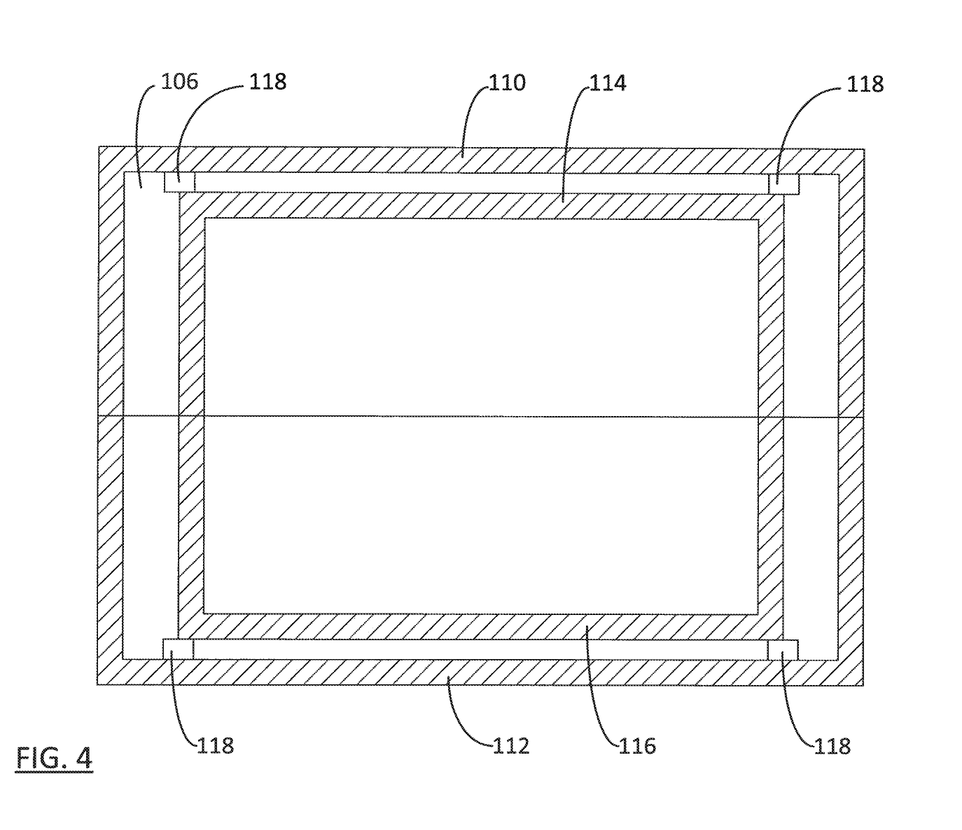

Referring now to FIGS. 1-4, one example of a test fixture 100 is described. The test fixture 100 includes a first barrier structure 102 and a second barrier structure 104. The first barrier structure 102 includes a first barrier upper half 110 and a first barrier lower half 112. The second barrier structure 104 includes a second barrier upper half 114 and a second barrier lower half 116. Isolators 118 connect the first barrier structure 102 and the second barrier structure 104. A test fixture bed (not shown in FIGS. 1-5) is disposed within the second barrier structure 104. On this test fixture bed are placed the devices to be tested, for example, microphones or speakers.

The barrier structures 102 and 104 may be constructed from a metal such as iron or steel. Other examples of materials may also be used. An air gap 106 is disposed between the first barrier structure 102 and the second barrier structure 104. It will be appreciated that other materials may also be disposed between the two barrier structures 102 and 104 or that a vacuum may be used.

It will be appreciated that the first barrier structure 102 provides an outer barrier and this barrier at least partially surrounds or encompasses the second and inner barrier structure 104. Together, the bottom portion 116 of the second barrier structure 104 and the test bed form an inner core. To open the test fixture 100, the various upper halves are removed (either together or one by one) to expose the test bed in the inner core and allow the user to position devices at or on the test bed.

When the fixture 100 is in the open position, the inner core is rigidly fixed in place to provide a consistent location for the tested parts to be inserted and removed from the test fixture 100. When the test fixture 100 is closed to begin testing, the inner core 104 is only attached to the outer shell 102 through the isolators 118 (and flexible wiring to provide the electrical connections) and this provides maximum isolation for the tested devices. In other words, vibrations of the fixture 100 and/or acoustic energy originating from outside the fixture 100 are prevented from affecting the devices being tested (or substantially reduced or eliminated). The isolators 118 provide for cushioning for vibrations and the air (or a vacuum or other material) between the barrier structures 102 and 104 provides acoustic isolation for the devices being tested within the inner core from unwanted acoustic energy. In other aspects, the barrier structures 102 and 104 may also shield the tested parts from electromagnetic radiation that may also adversely affect the testing.

In one example, the isolators 118 are constructed of a viscoelastic polymer and may be shaped as a cylinder or any other convenient structure. Other materials may also be used. An air gap of sufficient width to prevent barriers from contacting one another may be used. Other dimensions may also be used. It will also be appreciated that the air gap may be filled or partially filled with another material such as a viscoelastic polymer or a vacuum may be used.

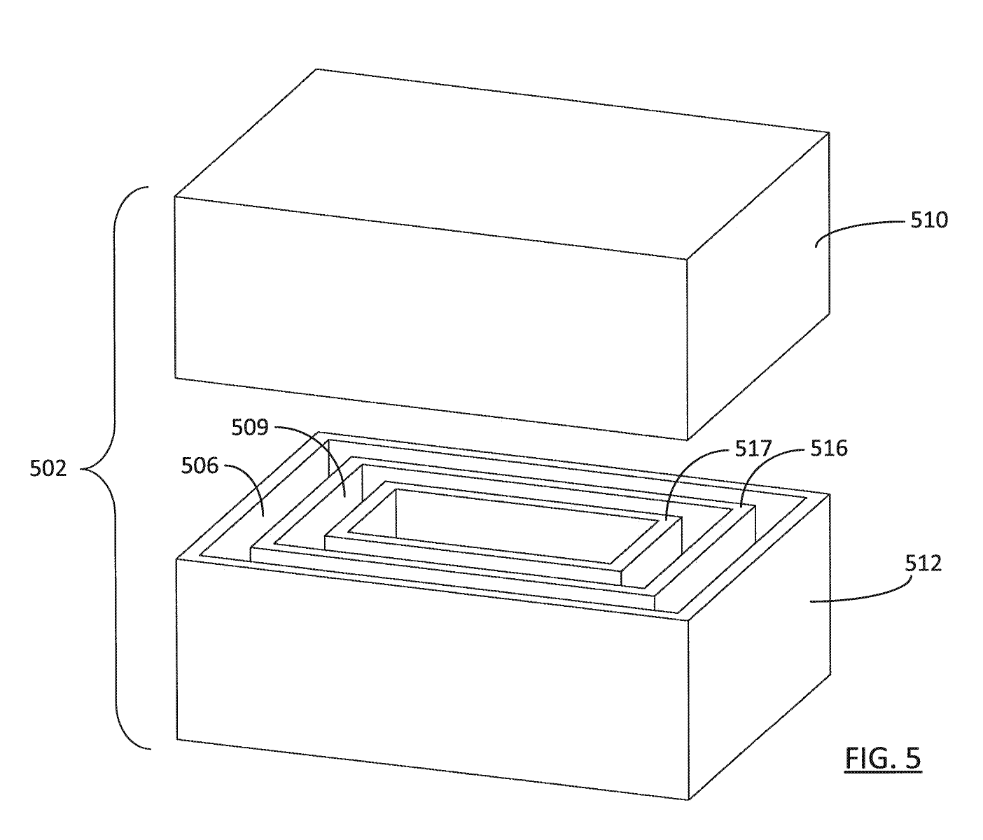

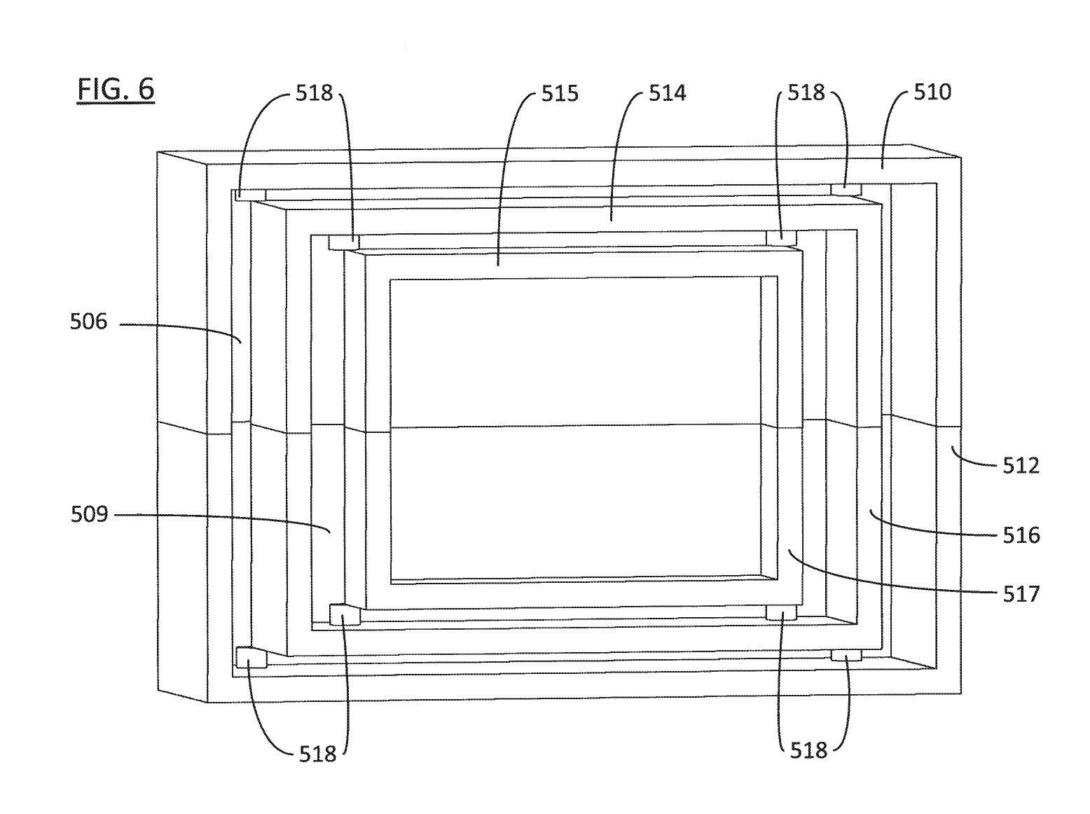

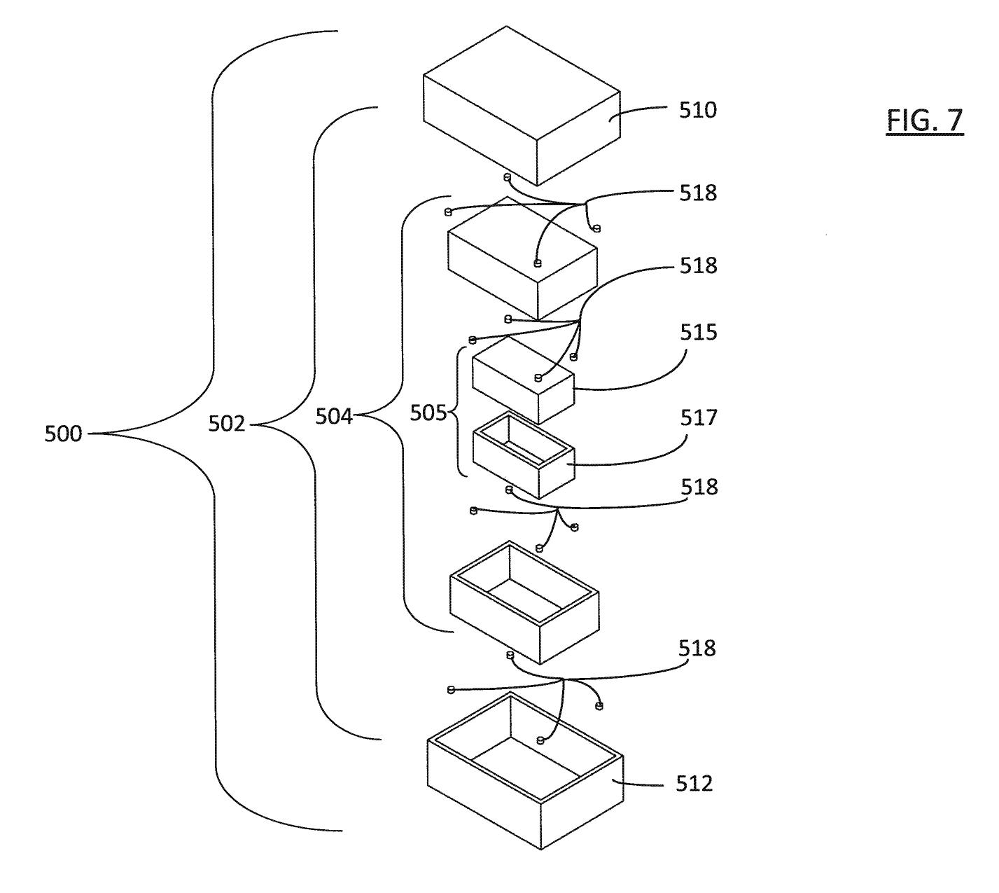

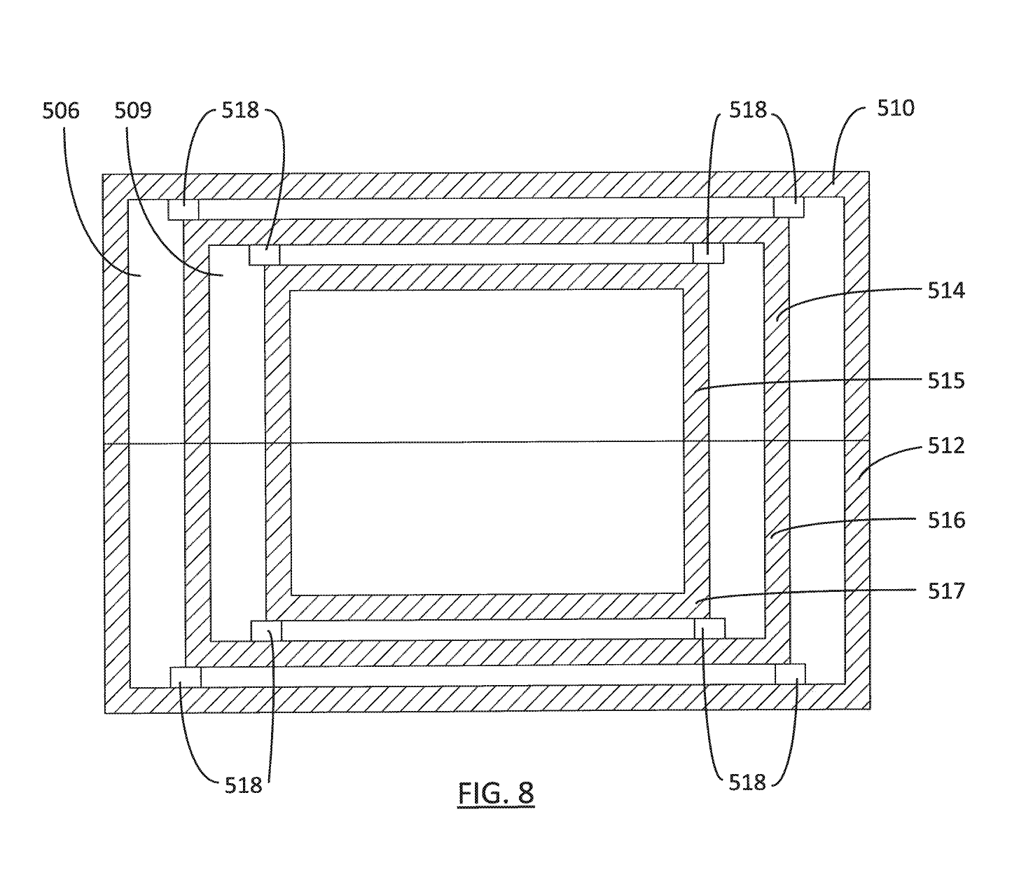

Referring now to FIGS. 5-8, another example of a test fixture 500 is descried. The test fixture 500 includes a first barrier structure 502, a second barrier structure 504, and a third barrier structure 505. The first barrier structure 502 includes a first barrier upper half 510 and a first barrier lower half 512. The second barrier structure 504 includes a second barrier upper half 514 and a second barrier lower half 516. The third barrier structure 505 includes a third barrier upper half 515 and a third barrier lower half 517. Isolators 518 connect the first barrier 502 and the second barrier 504. Isolators 518 also connect the second barrier structure 504 and the third barrier structure 505. A test fixture bed (not shown in FIGS. 5-8) is disposed within the third barrier structure 505. On this test fixture bed are placed the devices to be tested, for example, microphones or speakers.

The barrier structures 502, 504, and 505 may be constructed from iron or steel. Other examples of materials may also be used. An air gap 506 is disposed between the first barrier structure 502 and the second barrier structure 504. An air gap 509 is disposed between the second barrier structure 504 and the third barrier structure 505. It will be appreciated that other materials may also be disposed between the two barrier structures 502 and 504, and the barrier structures 504 and 505 or a vacuum may be used.

It will be appreciated that the first barrier structure 502 is an outer barrier and this barrier structure at least partially surrounds or encompasses the second barrier structure 504. In turn, the second barrier structure 504 at least partially surrounds and encompasses the third barrier structure 505. Together, the lower portion 517 of the third barrier structure 505 and the test bed form an inner core. When the fixture 500 is in the open position, the inner core is rigidly fixed to provide a consistent location for the tested parts to be inserted and removed from the test fixture. When the test fixture 500 is closed to begin testing, the inner core 505 is only attached to the barrier structure 504 through the isolators 518 (and flexible wiring to provide the electrical connections), the second barrier 504 is only connected to the first barrier 502 via the isolators 518, and this arrangement provides maximum isolation for the tested devices. In other words, vibrations of the fixture 500 are absorbed or substantially absorbed by the isolators 518. Acoustic energy originating from outside the fixture 500 is prevented or substantially prevented from entering the inner core by the air gaps 506 and 509 as well as the barrier structures. More specifically, the isolators 518 provide for cushioning for vibrations and the air (or other material) between the barrier 502 and 504 provides isolation for the devices being tested within the inner core, the isolation being from the vibrations affecting the fixture 500 and acoustic energy originating from outside the fixture. In other aspects, the barriers 502, 504, and 505 also shield the tested parts from electromagnetic radiation that may also adversely affect the testing.

In one example, the isolators 518 are constructed of a viscoelastic polymer and may be shaped as a cylinder or any other convenient structure. Other materials may also be used. An air gap of sufficient width to prevent barriers from contacting one another may be used. Other dimensions may also be used. It will also be appreciated that the air gaps may be filled or partially filled with another material such as a viscoelastic polymer or a vacuum may be used.

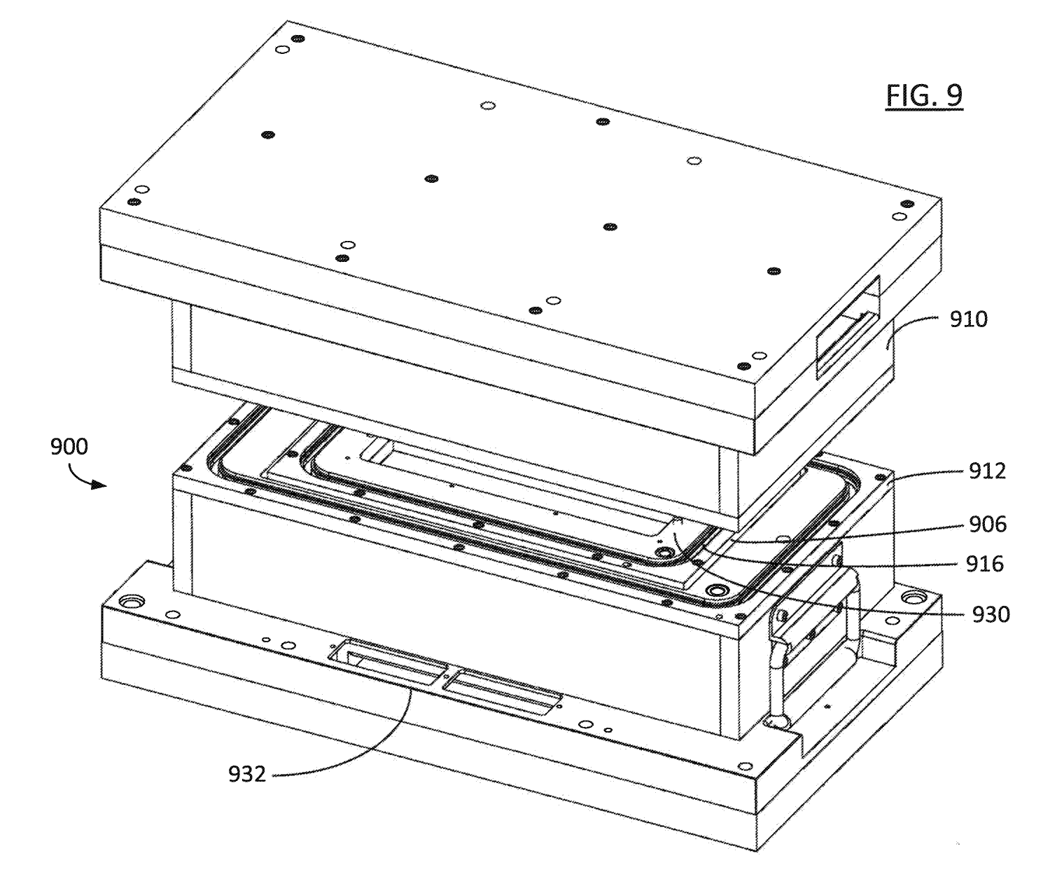

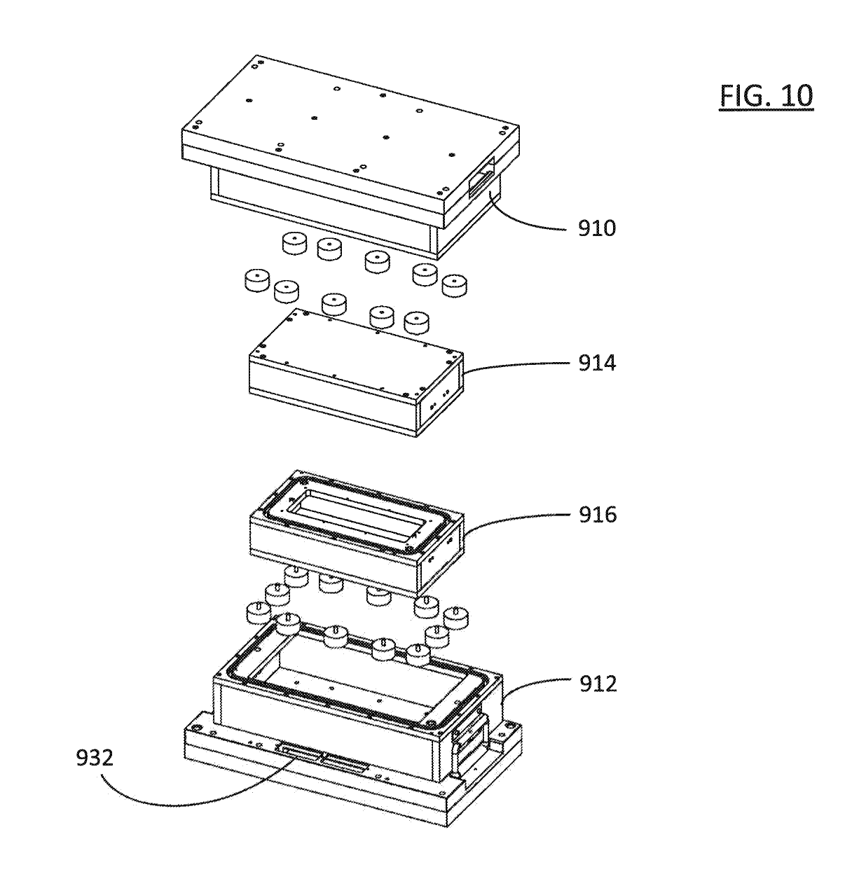

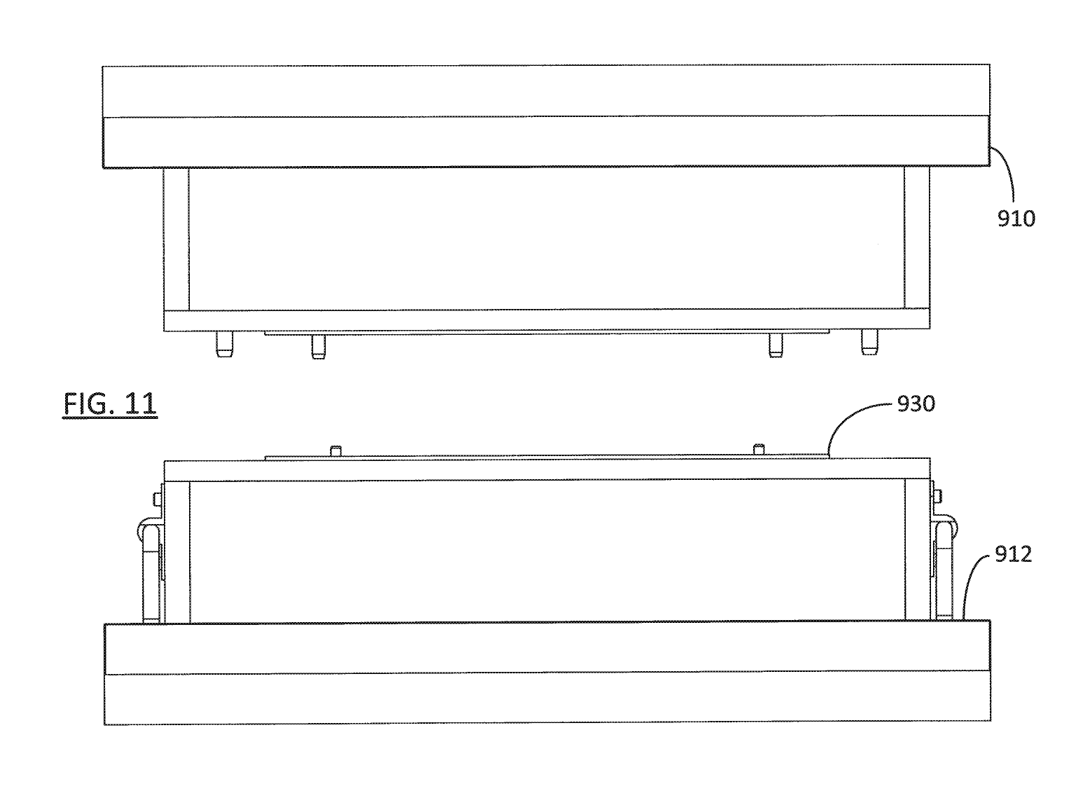

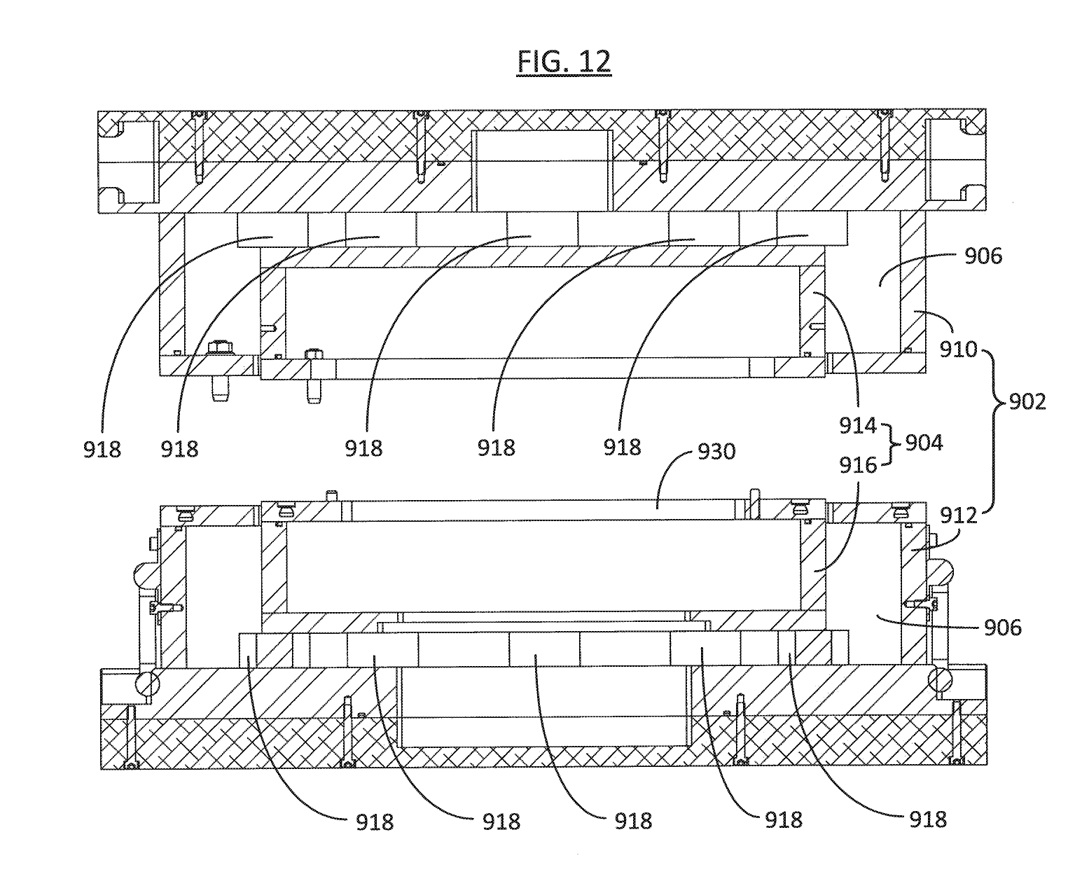

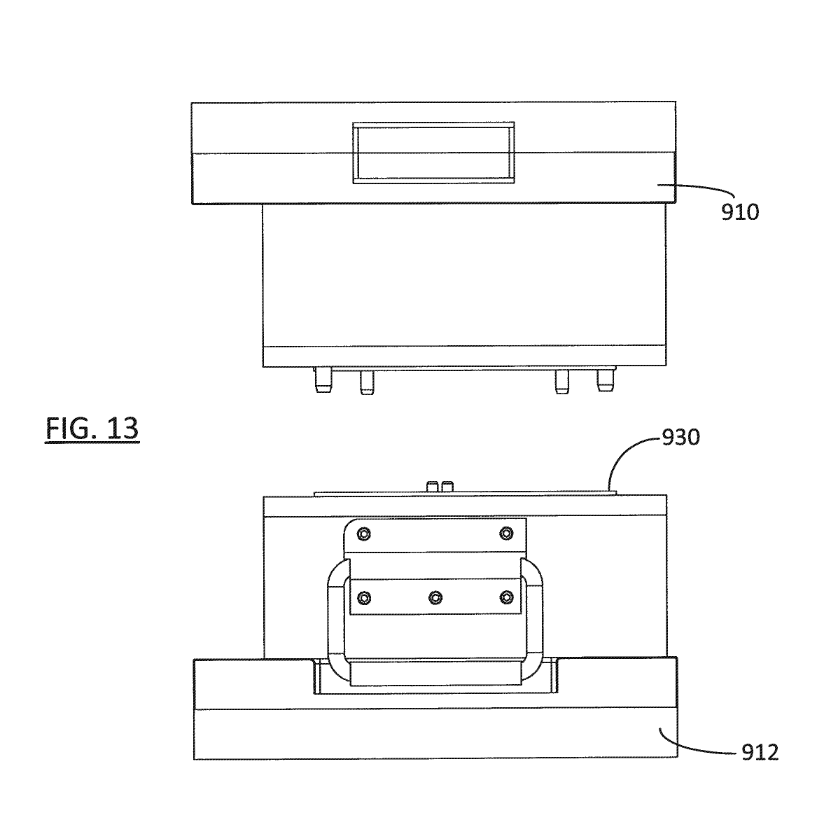

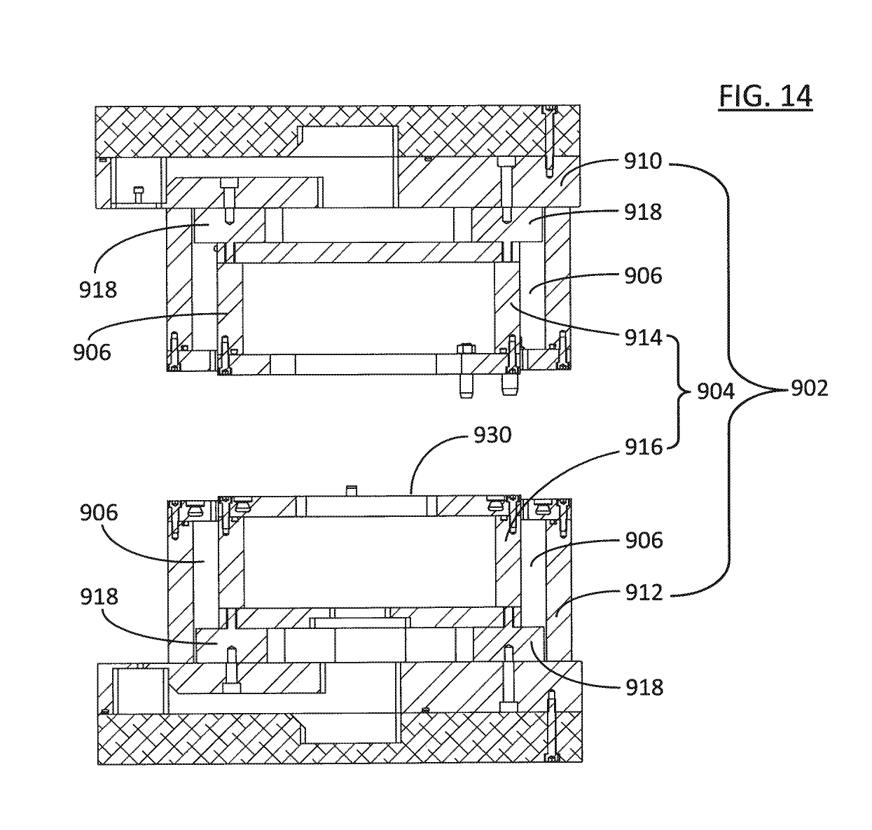

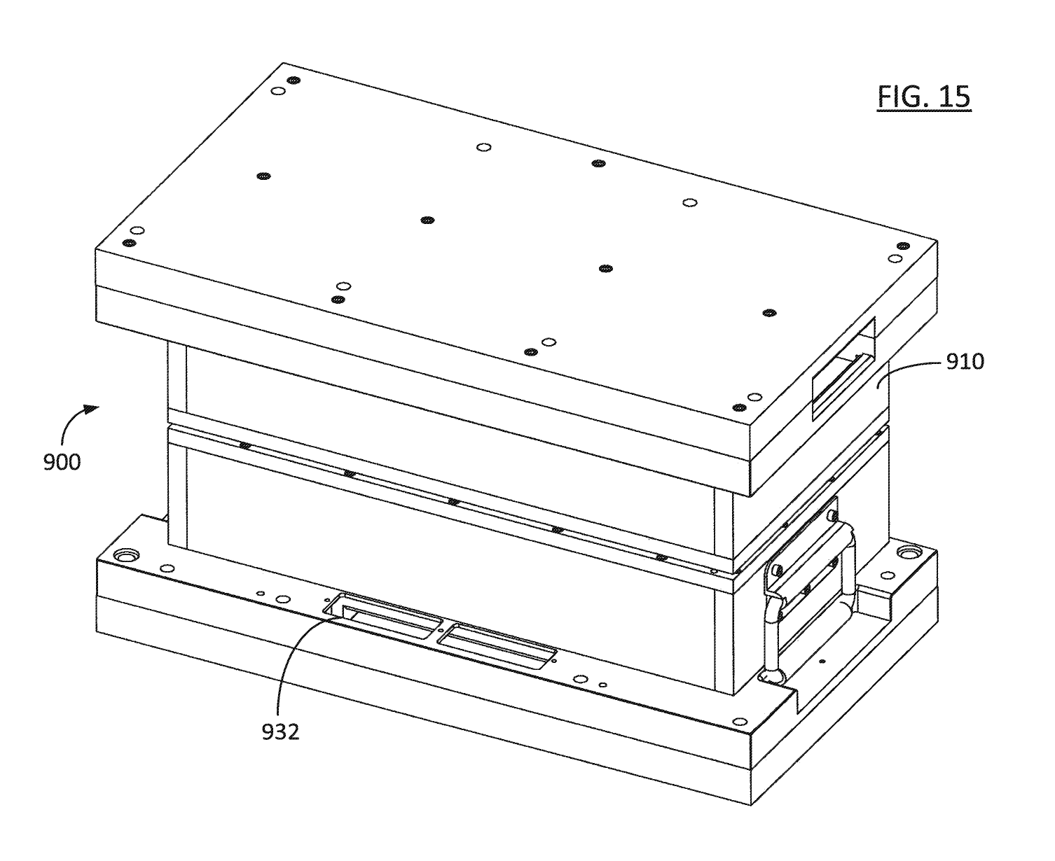

Referring now to FIGS. 9-15, another example of a test fixture 900 is described. The test fixture 900 includes a first barrier structure 902 and a second barrier structure 904. The first barrier structure 902 includes a first barrier upper half 910 and a first barrier lower half 912. The second barrier structure 904 includes a second barrier upper half 914 and a second barrier lower half 916. Isolators 918 connect the first barrier structure 902 and the second barrier structure 904. A test fixture bed 930 is disposed within the second barrier 904. On or at this test fixture bed 930 are placed devices (not shown) to be tested, for example, microphones or speakers. Connectors 932 couple an external test source (e.g., a voltage or current source) to the devices to be tested. It will be understood that various internal electrical connections are provided from the connectors to the test bed 930, but for simplicity these connections are not shown here.

The barrier structures 902 and 904 may be constructed from steel or iron. Other examples of materials may also be used. An air gap 906 is disposed between the first barrier structure 902 and the second barrier structure 904. It will be appreciated that other materials may also be disposed between the two barrier structures 902 and 904 or that a vacuum may also be used.

It will be appreciated that the first barrier structure 902 is an outer barrier and this barrier at least partially surrounds or encompasses the second and inner barrier structure 904. When the fixture 900 is in the open position, the test fixture bed 930 is rigidly fixed to provide a consistent location for the tested parts to be inserted and removed from the test fixture. Together, the lower portion 916 of the barrier structure 904 and the test bed 930 form an inner core. When the test fixture is closed to begin testing, the inner core is only attached to the outer barrier structure 902 through the isolators 918 (and flexible wiring to provide the electrical connections) and this provides maximum isolation for the tested devices. In other words, vibrations of the fixture 900 and/or acoustic energy originating from outside the fixture 900 are prevented from affecting the tested devices. In fact, the isolators 918 provide for cushioning for vibrations and the air (or other material) gap between the barrier structures 902 and 904 provides acoustic isolation for the devices being tested within the inner core from undesired acoustic energy. In other aspects, the barriers 902 and 904 also shield the tested parts from electromagnetic radiation that may also adversely affect the testing.

In one example, the isolators 918 are constructed of a viscoelastic polymer and may be shaped as a cylinder or any other convenient structure. Other materials may also be used. In other examples, the air gap 906 is approximately one inch wide. Other dimensions may also be used. It will also be appreciated that the air gap may be filled or partially filled with another material such as a viscoelastic polymer or may be a vacuum.

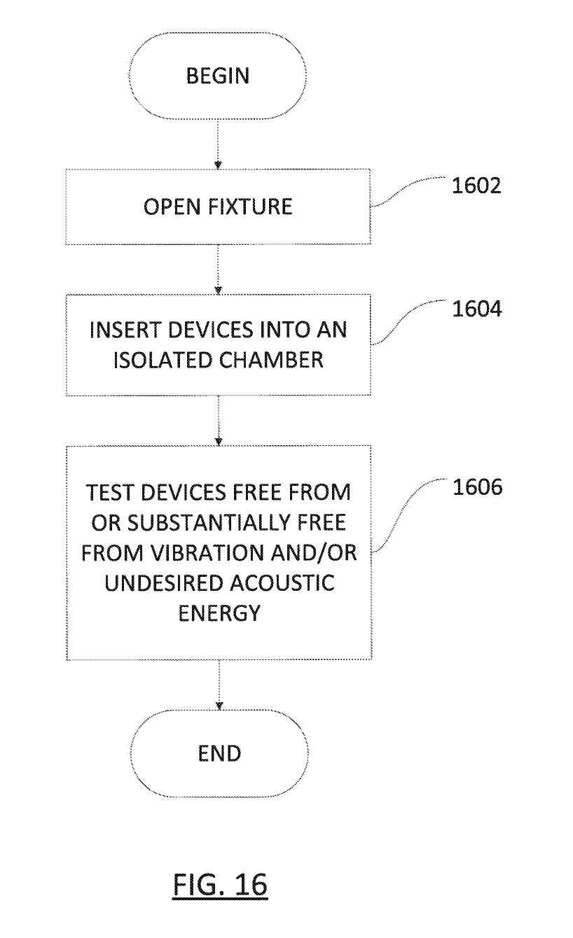

Referring now to FIG. 16, one example of an approach for testing acoustic devices is described. At step 1602, a test fixture is opened. The test fixture includes a first barrier structure, a second barrier structure, a gap between the first barrier structure and the second barrier structure, at least one isolator disposed in the gap, the isolator being configured to couple the first barrier structure to the second barrier structure, and a test bed disposed within the second barrier structure and configured to have acoustic devices coupled thereto.

At step 1604, at least one device to be tested is coupled to the test bed. At step 1606, the fixture is closed and the at least one device is tested. In this respect, the first barrier structure, the second barrier structure, the gap, and the at least one isolator act and are effective to dampen vibrations of the fixture and provide an acoustic isolation for the at least one acoustic device at the test bed from acoustic energy originating from outside the fixture.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A test fixture comprising:
a first barrier structure;
a second barrier structure;
a gap between the first barrier structure and the second barrier structure;
at least one isolator disposed in the gap, the isolator being configured to couple the first barrier structure to the second barrier structure;
a test bed disposed within the second barrier structure and configured to have acoustic devices coupled thereto;
such that the first barrier structure, the second barrier structure, the gap, and the at least one isolator act and are effective to dampen vibrations of the fixture and provide an acoustic isolation for the acoustic devices at the test bed from acoustic or vibrational energy originating from outside the fixture.

2. The test fixture of claim 1 wherein the at least one isolator is constructed from a viscoelastic polymer.

3. The test fixture of claim 1 further comprising a third barrier structure that is disposed within the second barrier structure and the third barrier structure holds the test bed.

4. The test fixture of claim 1 wherein the gap comprises an air gap.

5. The test fixture of claim 1 wherein the first barrier structure and the second barrier structure are constructed from a metal.

6. A method of testing at least one acoustic device, the method comprising:
opening a test fixture, the test fixture including a first barrier structure, a second barrier structure, a gap between the first barrier structure and the second barrier structure, at least one isolator disposed in the gap, the isolator being configured to couple the first barrier structure to the second barrier structure, and a test bed disposed within the second barrier structure and configured to have acoustic devices coupled thereto;
coupling at least one device to be tested to the test bed;
testing the at least one device, such that the first barrier structure, the second barrier structure, the gap, and the at least one isolator act and are effective to dampen vibrations of the fixture and provide an acoustic isolation for the at least one acoustic device at the test bed from acoustic or vibrational energy originating from outside the fixture.

7. The method of claim 6 wherein the at least one acoustic device comprises a microphone.

8. The method of claim 6 wherein the at least one isolator is constructed from a viscoelastic polymer.

9. The method of claim 6 further comprising a third barrier structure that is disposed within the second barrier structure and the third barrier structure holds the test bed.

10. The method of claim 6 wherein the gap comprises an air gap.

11. The method of claim 6 wherein the first barrier structure and the second barrier structure are constructed from a metal.
